(19) United States
(12) Patent Application Publication
(10) Pub. No.: US 2012/0137027 A1
(43) Pub. Date: May 31, 2012

(54) SYSTEM AND METHOD FOR MONITORING INPUT/OUTPUT PORT STATUS OF PERIPHERAL DEVICES

(75) Inventors: Quan-Jie Zheng, Tianjin (CN); Chih-Jen Chin, Taipei (TW); Ya-Jing Fan, Tianjin (CN); Chih-Feng Chen, Taipei (TW)

(73) Assignee: INVENTEC CORPORATION, Taipei (TW)

(21) Appl. No.: 13/070,836

(22) Filed: Mar. 24, 2011

(30) Foreign Application Priority Data
Nov. 30, 2010 (CN) 201010590922.4

(51) Int. Cl. G06F 3/00

(52) U.S. Cl. 710/19

(57) ABSTRACT

A system and method for monitoring an input/output port status of peripheral devices are used for monitoring an operating status of each peripheral device of a main board. The system includes at least one peripheral device, a complex programmable logic device (CPLD), and an output apparatus. The CPLD is electrically connected to the peripheral devices. The CPLD further includes a protocol conversion unit and multiple data registers. The protocol conversion unit converts an operating status of the CPLD or the peripheral devices into device status information. The data register is used for storing the device status information. The output apparatus is electrically connected to the CPLD. The output apparatus is used for displaying the device status information in the data register. A user can observe the operating status of each of the peripheral devices of the main board conveniently.

### CROSS-REFERENCE TO RELATED APPLICATIONS

This non-provisional application claims priority under 35 U.S.C. §119(a) on Patent Application No(s). 201010590922.4 filed in China, P.R.C. on Nov. 30, 2010, the entire contents of which are hereby incorporated by reference.

### BACKGROUND OF THE INVENTION

1. Field of the Invention

The present invention relates to a monitoring system and method, and more particularly to a monitoring system and method for monitoring an operating status of each peripheral device of a main board.

2. Related Art

In the prior art, a substrate management control unit is used to detect operation of a main board. FIG. 1 is a schematic architectural view of peripheral devices in a main board in the prior art. Generally, to achieve normal operation of a main board 100, a power supply unit needs to normally supply power to the main board 100. If the power supplied by the power supply unit is not stable, peripheral devices in the main board 100 may be damaged.

In the main board 100 in the prior art, a complex programmable logic device (CPLD) 110 is disposed. However, in the prior art, the CPLD 110 is only used for controlling the power supply unit to control power on of peripheral devices (such as a fan 120, a central processing unit 130, or a platform controller hub (PCH) 140). In other words, the CPLD 110 is only responsible for power switching of the peripheral devices, and does not monitor the power of the peripheral devices.

After an anomaly occurs, the manufacturer cannot know which peripheral device has an error. As for the prior art, the peripheral devices have to be detected one by one through an oscilloscope or other apparatuses. Such a process can only be implemented manually, and therefore, the time and labor taken for detecting an abnormal device is a heavy burden for the manufacturer.

### SUMMARY OF THE INVENTION

Accordingly, the present invention is a system for monitoring an input/output port status of peripheral devices, for monitoring an operating status of each peripheral device of a main board.

The system for monitoring the input/output port status of the peripheral devices according to the present invention comprises at least one peripheral device, a CPLD, and an output apparatus. The CPLD is electrically connected to the peripheral devices. The CPLD further comprises a protocol conversion unit and multiple data registers. The protocol conversion unit converts an operating status of the CPLD or the peripheral devices into device status information. The data register is used for storing the device status information. The output apparatus is electrically connected to the CPLD. The output apparatus is used for displaying the device status information in the data register.

The present invention is also a method for monitoring an input/output port status of peripheral devices, for monitoring an operating status of each peripheral device of a main board.

The method for monitoring the input/output port status of the peripheral devices according to the present invention comprises: enabling the main board, and driving a CPLD to sequentially select and power on any one of the peripheral devices; converting a power on self test (POST) code of the CPLD into device status information, and storing the device status information into a data register during booting of the main board; and when the CPLD accesses data in the peripheral devices, the CPLD converting access status information of the peripheral devices into the device status information through a protocol conversion unit, and storing the device status information into other data registers.

The present invention provides a system and method for monitoring an input/output port status of peripheral devices. The CPLD of the present invention records the operating status of the peripheral devices through the data registers, so that a user can observe the operating status of each of the peripheral devices conveniently.

### BRIEF DESCRIPTION OF THE DRAWINGS

The present invention will become more fully understood from the detailed description given herein below for illustration only, and thus are not limitative of the present invention, and wherein:

FIG. 1 is a schematic architectural view of peripheral devices in a main board in the prior art;

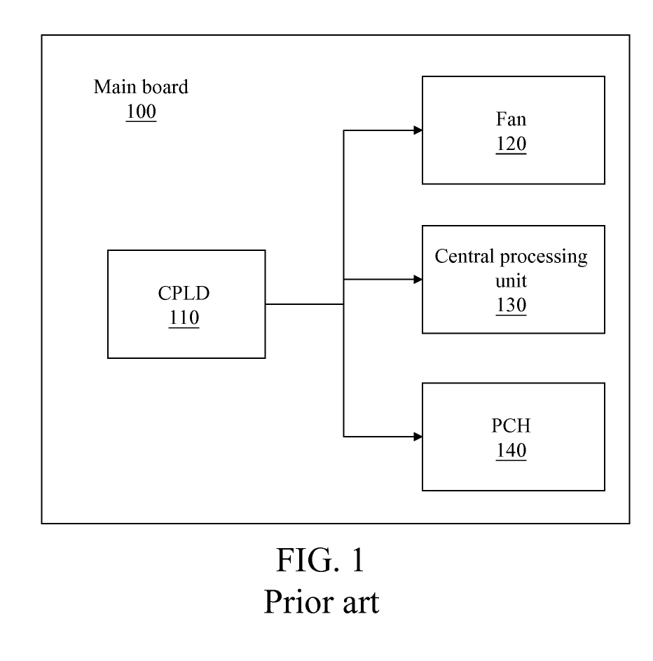

FIG. 2 is a schematic architectural view of the present invention; and

FIG. 3 is a schematic flow chart of operation of the present invention.

### DETAILED DESCRIPTION OF THE INVENTION

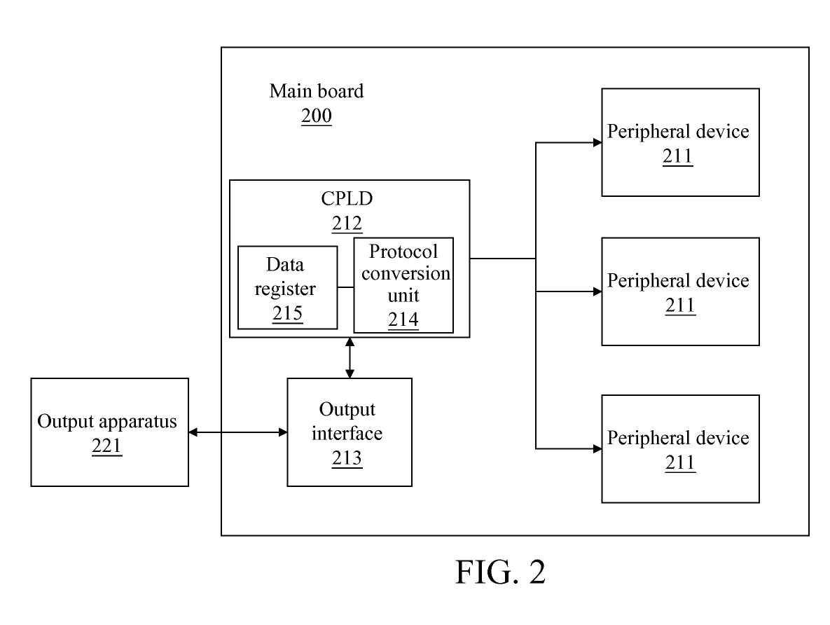

FIG. 2 is a schematic architectural view of the present invention. Referring to FIG. 2, a system for monitoring an input/output port status of peripheral devices comprises: at least one peripheral device 211, a CPLD 212, and an output apparatus 221. The peripheral device 211 may be, but not limited to, a south bridge chipset, a new generation peripheral component interconnect express (PCI-E), an internal intelligent platform management bus (IPMB), a dual in-line memory module (DIMM), a serial port, a network connector, or a fan.

The CPLD 212 is electrically connected to the peripheral devices 211 through an output interface 213. The output interface 213 is not limited to a serial peripheral interface (SPI) bus or an inter-integrated circuit (I2C) bus. The CPLD 212 further comprises a protocol conversion unit 214 and multiple data registers 215. The protocol conversion unit 214 converts an operating status of the CPLD 212 or the peripheral devices 211 into device status information. The data register 215 is used for storing the device status information. The output apparatus 221 is electrically connected to the CPLD 212. The output apparatus 221 is used for receiving the device status information from the CPLD 212, and the output apparatus 221 displays the device status information in the data register 215.

Generally, a main board 200 performs different access operations on the peripheral devices 211 during booting and operation. Therefore, the present invention performs corresponding monitoring during different operation periods of the main board 200. During the booting of the main board 200, the CPLD 212 drives a corresponding register to perform the booting according to a POST program. In the present invention, the CPLD 212 records a status of the register during the POST in the data registers 215. During each POST period, the protocol conversion unit 214 reads values recorded in the data registers 215, and coverts the recorded values into corresponding device status information. The protocol conversion unit 214 further transmits the device status information to the output apparatus 221. The output apparatus judges whether the device status information is the same as a default value. During the POST, status values of the peripheral devices are constant. Therefore, when an anomaly occurs to the status value of a peripheral device, it means that the peripheral device may be damaged or other problems occur to the peripheral device.

During the operation of the main board 200, the main board 200 starts to invoke the peripheral devices 211 connected to the main board 200 through the CPLD 212. Therefore, when the CPLD 212 invokes the peripheral devices 211, the CPLD 212 records a data input/output status of the peripheral devices 211 in the data registers 215.

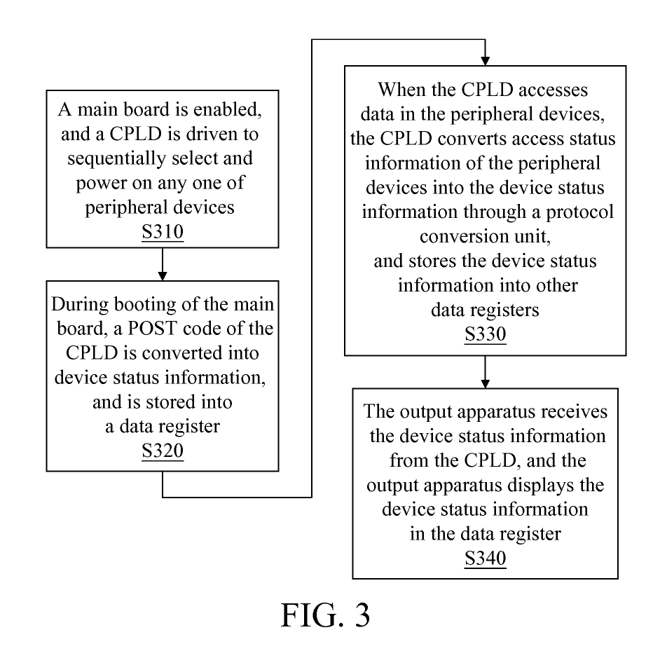

In order to clearly describe the operation of the present invention, reference is made to FIG. 3, which is a schematic flow chart of operation of the present invention.

In Step S310, a main board is enabled, and a CPLD is driven to sequentially select and power on any one of peripheral devices.

In Step S320, during booting of the main board, a POST code of the CPLD is converted into device status information, and is stored into a data register.

In Step S330, when the CPLD accesses data in the peripheral devices, the CPLD converts access status information of the peripheral devices into the device status information through a protocol conversion unit, and stores the device status information into other data registers.

In Step S340, the output apparatus receives the device status information from the CPLD, and the output apparatus displays the device status information in the data register.

First, the main board 200 is powered on and enabled, so that the CPLD 212 sequentially drives each of the peripheral devices 211. The description of the present invention is divided into two parts: the POST of the main board 200 and the operation of the main board 200. During booting of the main board 200, a basic input/output system (BIOS) performs corresponding driving processing on the CPLD 212 according to a POST code.

After relevant procedures of the booting are completed, a process of driving and invoking each of the peripheral devices 211 is started. The CPLD 212 accesses data in different peripheral devices 211 according to instructions delivered by an application program. For example, the CPLD 212 is connected to a substrate management controller through an I2C bus. When the substrate management controller starts to be tested, the CPLD 212 records data transmitted from the substrate management controller into the data registers 215 in real time.

Then, the output apparatus 221 is electrically connected to the CPLD through a system management bus (SMBus), an I2C bus or an SPI bus. The output apparatus 221 starts to read data recorded in the data registers 215. As described above, during the POST, the constant data is accessed, and therefore, response data of each POST should be the same. When wrong data is recorded in the data registers 215, once the output apparatus 221 finds a difference between the wrong data and correct data, the output apparatus 221 informs a user of the abnormality through a built-in light-emitting diode (LED) or speaker.

In order to clearly describe the data recorded in the data registers 215 of the present invention, recording of an 8-bit power enable status into 8-bit data registers 215 is taken as an example for description. A value of a status string of the power enable status is defined as follows:

TABLE 1
Bit Information Table of Power Enable Status

| Bit | | |
|---|---|---|
| position | Signal name | Functional description |
| 7 | VR_PVTT_EN | CPU_PVTT enable |
| | | ‘1’: enabled |
| | | ‘0’: disabled |
| 6 | PAL_LV_DDR3_EN_N | Constant to ‘1’ |
| 5 | VR_P1V8_EN | CPU P1V8 enable |
| | | ‘1’: enabled |
| | | ‘0’: disabled |
| 4 | PAL_STANDBY_EN | Power standby enable |
| | | ‘1’: enabled |
| | | ‘0’: disabled |
| 3 | VR_P0V75_EN | CPU P0V75 enable |
| | | ‘1’: enabled |
| | | ‘0’: disabled |
| 2 | VR_P1V5_DDR3_EN | CPU P1V5 DDR3 enable |
| | | ‘1’: enabled |
| | | ‘0’: disabled |
| 1 | VR_P1V05_PCH_EN | CPU_PCH p1v05 enable |
| | | ‘1’: enabled |
| | | ‘0’: disabled |
| 0 | CTNR_PS_ON | Power supply enable |
| | | ‘1’:enabled |
| | | ‘0’: disabled |

Register address (Reg. ADDR): 20h
Access type: RO
Default value: 0x00

If a data format used by the output apparatus 221 is different from that of the data registers 215, format conversion may be performed by the protocol conversion unit 214. Referring to Table 1, it is assumed that when power is enabled, the data register 215 receives 8-bit status strings of an operating situation 1 and an operating situation 2. It is assumed that a default status string of the operating situation 1 is 0000 0011, and a default status string of the operating situation 2 is 0000 1100.

When the output apparatus 221 receives the status string 0000 0011 of the operating situation 1, the output apparatus 221 determines that the operating situation 1 is correct. If the output apparatus 221 receives a status string 0000 1111 of the operating situation 2, the output apparatus 221 determines that an error occurs to the operating situation 2.

The present invention provides a system and method for monitoring the status of the peripheral devices 211. The CPLD 212 of the present invention records the operating status of the peripheral devices 211 through the data registers 215, so that the user can observe the operating status of each of the peripheral devices 211 conveniently.

What is claimed is:

1. A system for monitoring an input/output port status of peripheral devices, for monitoring an operating status of each peripheral device of a main board, the system comprising:
at least one peripheral device;
a complex programmable logic device (CPLD), electrically connected to the peripheral devices, wherein the CPLD further comprises a protocol conversion unit and multiple data registers, the protocol conversion unit is used for converting an operating status of the CPLD or the peripheral devices into device status information, and the data register is used for storing the device status information; and
an output apparatus, electrically connected to the CPLD, wherein the output apparatus receives the device status information from the CPLD, and the output apparatus displays the device status information in the data register.

2. The system for monitoring the input/output port status of the peripheral devices according to claim 1, wherein the peripheral device is a south bridge chipset, a new generation peripheral component interconnect express (PCI-E), an internal intelligent platform management bus (IPMB), a dual in-line memory module (DIMM), a serial port, a network connector, or a fan.

3. The system for monitoring the input/output port status of the peripheral devices according to claim 1, wherein during booting of the main board, a power on self test (POST) code of the CPLD is converted into the device status information, and is stored into the data registers.

4. The system for monitoring the input/output port status of the peripheral devices according to claim 1, wherein when the CPLD accesses data in the peripheral devices, the CPLD converts access status information of the peripheral devices into the device status information through the protocol conversion unit, and stores the device status information into the data registers.

5. The system for monitoring the input/output port status of the peripheral devices according to claim 1, wherein the output apparatus is electrically connected to the CPLD through a system management bus (SMBus), an inter-integrated circuit (I2C) bus or a serial peripheral interface (SPI) bus.

6. A method for monitoring an input/output port status of peripheral devices, for monitoring an operating status of each peripheral device of a main board, the method comprising:
enabling the main board, and driving a complex programmable logic device (CPLD) to sequentially select and power on any one of the peripheral devices;
converting a power on self test (POST) code of the CPLD into device status information, and storing the device status information into a data register during booting of the main board; and
when the CPLD accesses data in the peripheral devices, the CPLD converting access status information of the peripheral devices into the device status information through a protocol conversion unit, and storing the device status information into other data registers.
